(19) United States
(12) Patent Application Publication
(10) Pub. No.: US 2014/0215734 A1
(43) Pub. Date: Aug. 7, 2014

(54) CLAMPING DEVICE AND WASHING DEVICE USING SAME

(71) Applicant: HON HAI PRECISION INDUSTRY CO., LTD., New Taipei (TW)

(72) Inventor: CHEN-HAN LIN, New Taipei (TW)

(73) Assignee: HON HAI PRECISION INDUSTRY CO., LTD., New Taipei (TW)

(21) Appl. No.: 14/059,454

(22) Filed: Oct. 22, 2013

(30) Foreign Application Priority Data
Feb. 4, 2013 (TW) 102104121

(51) Int. Cl. B08B 3/12; B08B 13/00; B08B 3/04

(52) U.S. Cl. CPC B08B 3/12; B08B 3/044; B08B 13/00
USPC 15/94; 269/55

(57) ABSTRACT

A clamping device is capable of clamping different types of workpieces. The clamping device includes a bracket, two rails, and two pairs of holding assemblies. The bracket includes a number of supporting poles. The two rails are movably supported on opposite two of the supporting poles. Each pair of holding assemblies are movably assembled to a rail. Each holding assembly holds a corner of a workpiece.

### BACKGROUND

1. Technical Field

The present disclosure relates to a clamping device and a washing device using the same.

2. Description of Related Art

After fabrication of a light guide plate, a clamping device is needed to clamp the light guide plate to transfer the light guide plate to a washing device for washing. However, different types of the light guide plates need different types of clamping devices, which is costly.

Therefore, it is desirable to provide a clamping device and a washing device using the same which can overcome the above-mentioned limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an assembled, isometric view of a washing device including a clamping device, according to an exemplary embodiment.

FIG. 2 is a cross-sectional view taken along line II-II of the washing device of FIG. 1.

FIG. 3 is an assembled, isometric view of the clamping device of FIG. 1.

FIG. 4 is an exploded, isometric view of the clamping device of FIG. 3.

### DETAILED DESCRIPTION

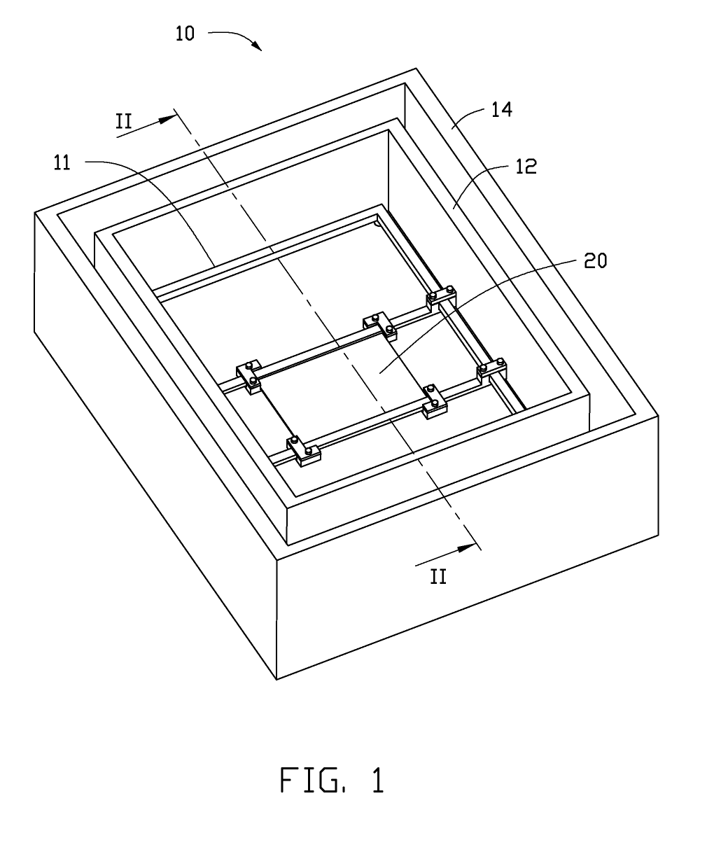

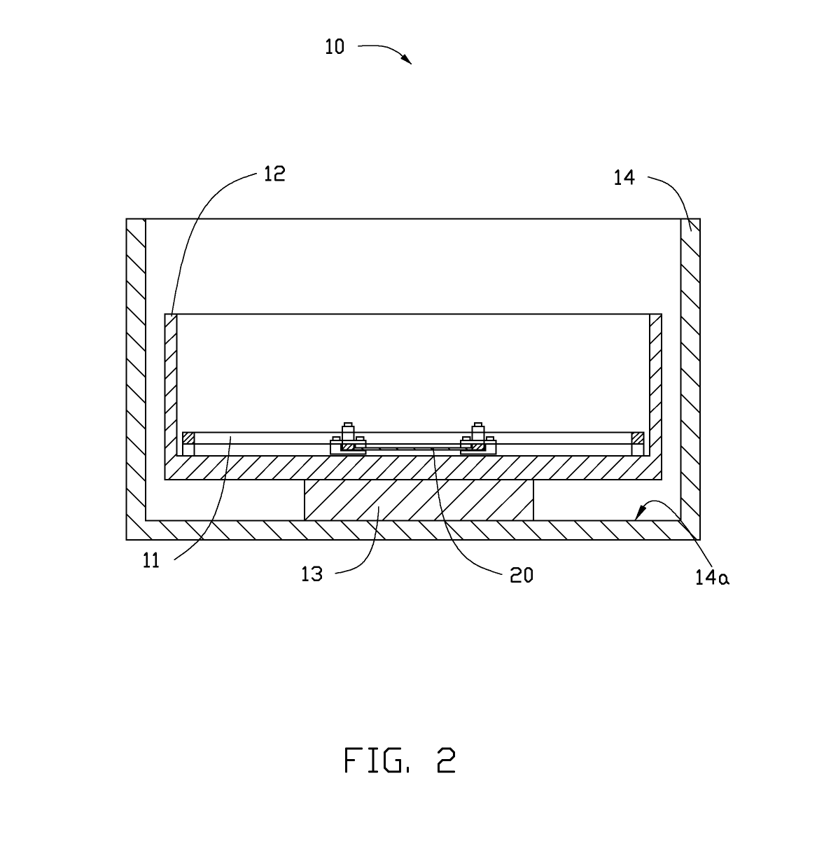

FIGS. 1-2 show a washing device 10 for washing different types of workpieces, according to an embodiment. In the illustrated embodiment, the workpieces are different types of light guide plates 20. The washing device 10 includes a clamping device 11, a receiving chamber 12, a vibrator 13, and a washing chamber 14. A shape and a size of the clamping device 11 respectively correspond to a shape and a size of the receiving chamber 12. The clamping device 11 is received in the receiving chamber 12. The vibrator 13 is received in the washing chamber 14 and is positioned on a bottom surface 14a of the washing chamber 14. The receiving chamber 12 is received in the washing chamber 14 and is supported on the vibrator 13. As such, the clamping device 11, the receiving chamber 12, and the vibrator 13 all are received in the washing chamber 14. In the embodiment, the vibrator 13 is an ultrasonic vibrator.

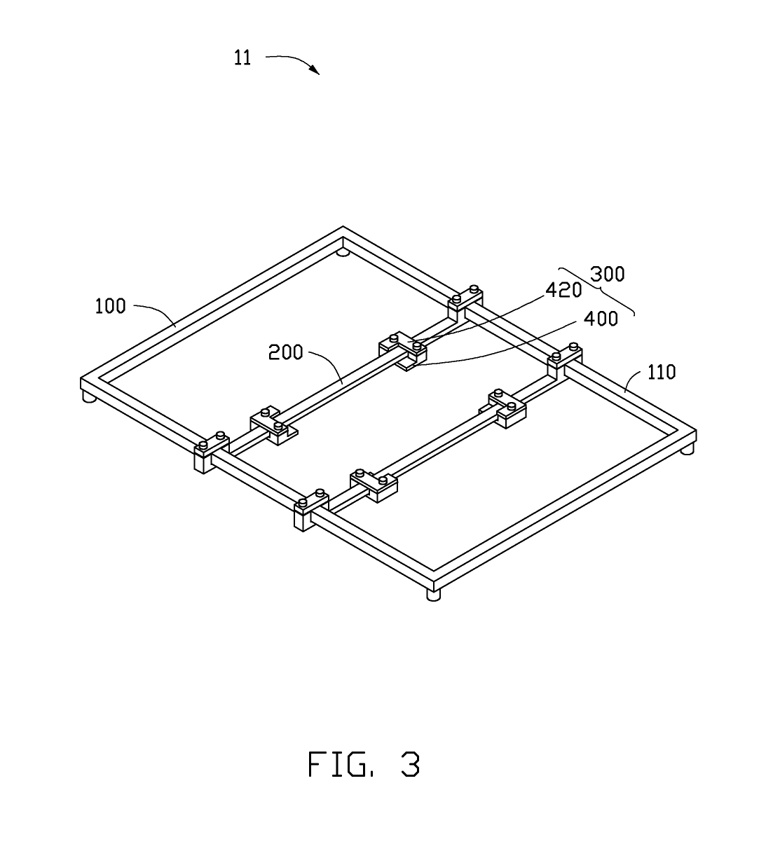

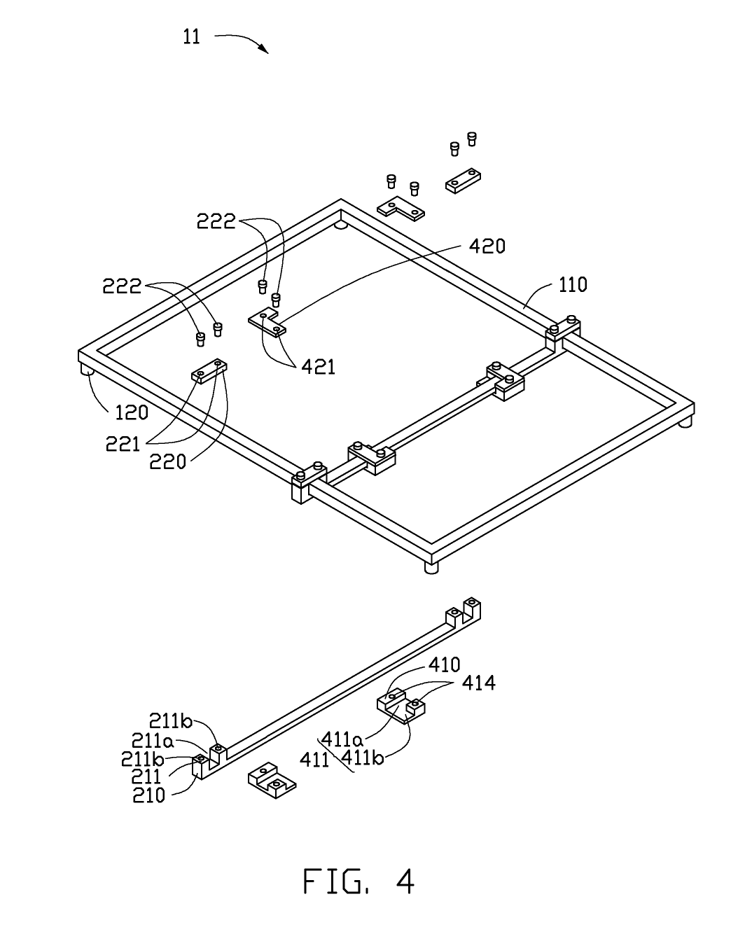

FIGS. 3-4 show the clamping device 11 for clamping different types of light guide plates 20. The clamping device 11 includes a bracket 100, two rails 200, and two pairs of holding assemblies 300.

The bracket 100 is substantially rectangular and formed by four supporting poles 110. Four supporting posts 120 respectively extend downward from a corner of the bracket 100. Four supporting posts 120 are supported on the bottom surface 14a of the washing chamber 14, to make the supporting pole 110 and the bottom surface 14a spaced a set distance from each other.

Two locating flanges 210 respectively extend upward from two ends of each rail 200. Each locating flange 210 includes a top surface 211. The top surface 211 defines a first receiving cavity 211a and two first threaded holes 211b. In the embodiment, the two first threaded holes 211b are symmetrical about the first receiving cavity 211a. A shape and a size of the first receiving cavity 211 a respectively correspond to a shape and a size of the supporting pole 110. The clamping device 11 also includes four first fixing plates 220 and eight screw bolts 222. Each first fixing plate 220 defines two second threaded holes 221 spatially corresponding to the first threaded holes 211b. In assembly, each supporting pole 110 is partly received in the first receiving cavity 211a, each first fixing plate 220 covers the top surface 211 of the locating flange 210, with each second threaded hole 221 aligning with a corresponding first threaded hole 211b, then each screw bolt 222 is threadedly engaged with a corresponding second threaded hole 221 and a corresponding first threaded hole 211b to assemble the first fixing plate 220 onto the top surface 211. As such, each rail 200 is movably positioned on two opposite supporting poles 110.

Each holding assembly 300 is movably assembled to a rail 200. In particular, each holding assembly 300 includes two moveable portions 400 and two second fixing plates 420. The two moveable portions 400 are axially symmetrical about the rail 200. Each movable portion 400 includes an upper surface 410. The upper surface 410 defines a second receiving cavity 411 at a center. The second receiving cavity 411 is substantially L shaped, and includes a first receiving portion 411 a and a second receiving portion 411b communicating with the first receiving portion 411a. The upper surface 410 also defines two third threaded holes 414.

Each second fixing plate 420 defines two fourth threaded holes 421 spatially corresponding to the third threaded holes 414. In assembly, each rail 200 is partly received in the first receiving portion 411a, each second fixing plate 420 covers the upper surface 410 of the movable portion 400, with each fourth threaded hole 421 aligning with a corresponding third threaded hole 414, then a screw bolt 222 is threadedly engaged with a corresponding fourth threaded hole 421 and a corresponding third threaded hole 414 to assemble the second fixing plate 420 onto the upper surface 410. As such, each holding assembly 300 are movably positioned on the rail 200.

In use, when a type of light guide plate 20 needs washing, the rails 200 are moved along the supporting poles 110 adjusting a distance between the two rails 200, based on a width of the light guide plate 20. Then, moving the holding assemblies 300 along a lengthwise of the rail 200 adjusting a distance between the pair of the holding assemblies 300, based on a length of the light guide plate 20, making four corners of the light guide plate 20 held in a second receiving portion 411b. Then, water is added to the receiving chamber 12, and the vibrator 13 is turned on shaking the light guide plate 20.

In other embodiments, the washing chamber 14 can be omitted.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A clamping device being capable of clamping different types of workpieces, the clamping device comprising:
a bracket comprising a plurality of supporting poles;
two rails movably supported on opposite two of the supporting poles; and
two pairs of holding assemblies, each pair of holding assemblies movably assembled to a respective one of the rails, each holding assembly for holding a corner of a workpiece.

2. The clamping device of claim 1, wherein the bracket is substantially rectangular and comprises four supporting poles and four supporting posts respectively extending downward from a corner of the bracket.

3. The clamping device of claim 1, wherein each rail comprises two locating flanges respectively extending upward from two ends of each rail, each locating flange comprises a top surface, the top surface defines a first receiving cavity, a shape and a size of the first receiving cavity respectively correspond to a shape and a size of the supporting pole, the clamping device comprises four first fixing plates, each supporting pole is partly received in the first receiving cavity, each first fixing plate assembles onto the top surface.

4. The clamping device of claim 3, comprising a plurality of first screw bolts, wherein the top surface defines two first threaded holes, each first fixing plate defines two second threaded holes spatially corresponding to the first threaded holes, each first screw bolt is threadedly engaged with a corresponding second threaded hole and a corresponding first threaded hole to assemble the first fixing plate onto the top surface.

5. The clamping device of claim 4, wherein the two first threaded holes are symmetrical about the first receiving cavity.

6. The clamping device of claim 1, wherein each holding assembly comprises two moveable portions and two second fixing plates, each movable portion comprises an upper surface, the upper surface defines a second receiving cavity, the second receiving cavity is substantially L shaped, and comprises a first receiving portion and a second receiving portion communicating with the first receiving portion, each rail is partly received in the first receiving portion, the second fixing plate is assembled onto the upper surface, the second receiving portion is configured to hold the corner of the workpiece.

7. The clamping device of claim 6, comprising a plurality of second screw bolts, wherein the upper surface defines two third threaded holes, each second fixing plate defines two fourth threaded holes spatially corresponding to the third threaded holes, each second screw bolt is threadedly engaged with a corresponding fourth threaded hole and a corresponding third threaded hole to assemble the second fixing plate onto the upper surface.

8. A washing device being capable of clamping different types of workpieces, the washing device comprising:
a vibrator;
a receiving chamber supported on the vibrator; and
a clamping device being capable of clamping different types of workpieces, the clamping device received in the receiving chamber, the clamping device comprising:
a bracket comprising a plurality of supporting poles;
two rails movably supported on opposite two of the supporting poles; and
two pairs of holding assemblies, each pair of holding assemblies movably assembled to a respective one of the rails, each holding assembly for holding a corner of a workpiece.

9. The washing device of claim 8, comprising a washing chamber, wherein the washing chamber comprises a bottom surface, the bracket is substantially rectangular and comprises four supporting poles and four supporting posts respectively extending downward from a corner of the bracket, the supporting posts are supported on the bottom surface to make the supporting pole and the bottom surface be spaced each other by a distance.

10. The washing device of claim 8, wherein each rail comprises two locating flange respectively extending upward from two ends of each rail, each locating flange comprises a top surface, the top surface defines a first receiving cavity, a shape and a size of the first receiving cavity respectively correspond to a shape and a size of the supporting pole, the clamping device comprises four first fixing plates, each supporting pole is partly received in the first receiving cavity, each first fixing plate assembles onto the top surface.

11. The washing device of claim 10, wherein the clamping deceive comprises a plurality of first screw bolts, the top surface defines two first threaded holes, each first fixing plate defines two second threaded holes spatially corresponding to the first threaded holes, each first screw bolt is threadedly engaged with a corresponding second threaded hole and a corresponding first threaded hole to assemble the first fixing plate onto the top surface.

12. The washing device of claim 11, wherein the two first threaded holes are symmetrical about the first receiving cavity.

13. The washing device of claim 8, wherein each pair of holding assembly comprises two moveable portions and two second fixing plates, each movable portion comprises an upper surface, the upper defines a second receiving cavity, the second receiving cavity is substantially L shaped, and comprises a first receiving portion and a second receiving portion communicating with the first receiving portion, each rail is partly received in the first receiving portion, the second fixing plate is assembled onto the upper surface, the second receiving portion is configured to hold the corner of the workpiece.

14. The washing device of claim 13, wherein the clamping device comprises a plurality of second screw bolts, the upper surface defines two third threaded holes, each second fixing plate defines two fourth threaded holes spatially corresponding to the third threaded holes, each second screw bolt is threadedly engaged with a corresponding fourth threaded hole and a corresponding third threaded hole to assemble the second fixing plate onto the upper surface.

15. The washing device of claim 8, wherein the vibrator is an ultrasonic vibrator.
